(19) United States
(12) Patent Application Publication
(10) Pub. No.: US 2018/0039118 A1
(43) Pub. Date: Feb. 8, 2018

(54) NARROW FRAME IN CELL TYPE TOUCH DISPLAY PANEL STRUCTURE

(71) Applicant: Wuhan China Star Optoelectronics Technology Co. Ltd., Wuhan City (CN)

(72) Inventors: Caiqin Chen, Wuhan City (CN); Qipei Zhang, Wuhan City (CN)

(21) Appl. No.: 14/914,652

(22) PCT Filed: Jan. 29, 2016
(86) PCT No.: PCT/CN2016/072844

§ 371 Date: Feb. 26, 2016

(30) Foreign Application Priority Data
Dec. 22, 2015 (CN) 201510976720.6

(51) Int. Cl. G02F 1/1333; G06F 3/041; G02F 1/1343

(52) U.S. Cl. CPC G02F 1/13338; G02F 1/133308; G02F 1/134336; G06F 3/0412; G06F 3/0416

(57) ABSTRACT

The present invention provides a narrow frame In cell type touch display panel structure, and by locating m control signal lines (TL(1) to TL(N/m)), and N/m touch driving signal lines (CL(1) to CL(m)) and m TFTs (T1 to Tm) respectively located corresponding to each of the touch driving signal lines, the touch driving signal can be provided to the N touch driving electrodes (1). In comparison with prior art that the N touch driving signal lines of the same amount of the N touch driving electrodes are located, the present invention can reduce the amount of the signal lines in the frame regions at two sides of the panel to reduce the width of the frame regions for being beneficial to realization of the narrow frame design.

### FIELD OF THE INVENTION

The present invention relates to a display technology field, and more particularly to a narrow frame In cell type touch display panel structure.

### BACKGROUND OF THE INVENTION

The LCD (Liquid Crystal Display) possesses many advantages of being ultra thin, power saved and radiation free. It has been widely utilized in, such as LCD TVs, mobile phones, Personal Digital Assistant (PDAs), digital cameras, laptop screens or notebook screens.

With the development of the liquid crystal display technology, people have more demands for the display quality, appearance design, and the human machine interface of the liquid crystal display. The touch technology has properties of convenient operation and high integration, and thus becomes the skill development hot spot.

The touch technology has been developed rapidly in the recent years, and at present, there are kinds of touch technologies put into mass productions. For the touch display panels at present, according to the positions of the touch sensor, they can be categorized to be the On Cell which the touch sensors cover on the liquid crystal cells, the In Cell which the touch sensors are embedded in the liquid crystal cells and the Out Cell which the touch sensors are added on the display panel. The In Cell type touch display panel means that the touch function is embedded in to the liquid crystal pixels, which does not merely decrease the entire device thickness but the manufacture can be with the LCD together without the additional manufacture process and the influence of the visuality in the outdoor bright environment.

For the needs of usage convenience and beauty, the requirement of the narrow frame for the digital display products at present becomes more and more urgent. The narrow frame means that the no obvious frames are covering and pressing the periphery of the display panel, and the display panel appears to be simple, clear, fashion and graceful, which are the development trends of the liquid crystal displays.

Please refer to FIG. 1 and FIG. 2 at the same time, which is the In cell type touch display panel structure according to prior art, comprising a plurality of touch driving electrodes 10, which are separately arranged in parallel along a horizontal direction, and located in a middle region of the touch display panel, a plurality of touch sensing electrodes 20, which are separately arranged in parallel along a vertical direction, and insulated and crossed with the plurality of touch driving electrodes 10, touch driving circuits 30, which are located in two side regions of the touch display panel, and electrically coupled with all the touch driving electrodes 10, a GOA circuit 90 located at an external side of the touch driving circuit 30, a touch sensing circuit 40, which is located in lower region of the touch display panel, and electrically coupled with all the touch sensing electrodes 20, an IC driving module 50, which is electrically coupled to the touch driving circuits 30 and the touch sensing circuit 40. The touch driving circuits 30 comprises touch driving signal lines 301 of the same amount as the touch driving electrodes 10, and each touch driving signal line 301 is coupled to one corresponding touch driving electrode 10 through a bonding pad 302. For instance, if the amount of the touch driving electrodes is 30, then, the 30 touch driving signal lines 301 of the equal amount are required to be set up. As performing the touch operation, the touch driving signals generated by the IC driving module 50 are transmitted to the touch driving electrodes 10 through the touch driving signal lines 301 in the touch driving circuit 30. The sensing signals sensed by the touch sensing electrodes 20 is returned to the IC driving module 50 through the touch sensing circuit 40.

The amount of the touch driving signal lines 301 is related with the size of the display panel and the size of the bonding pad 302. The larger the display panel is and the smaller the bonding pad 302 is, the more touch driving signal lines 301 are required. Therefore, the drawbacks of the In cell type touch display panel structure according to prior art is: as being applied in the display panel of which the touch accuracy is higher (i.e. the bonding pad is smaller) and the size is larger, the amount of the touch driving electrodes 10 is more. The amount of the corresponding touch driving signal lines 301 is more, too. Thus, wider panel frame region will be occupied, which goes against the narrow frame design.

### SUMMARY OF THE INVENTION

An objective of the present invention is to provide a narrow frame In cell type touch display panel structure capable of reducing the amount of the signal lines in the frame regions at two sides of the panel to reduce the width of the frame regions for being beneficial to realization of the narrow frame design.

For realizing the aforesaid objective, the present invention provides a narrow frame In cell type touch display panel structure, comprising a plurality of touch driving electrodes, which are separately arranged in parallel along a horizontal direction, and located in a middle region of the touch display panel, a plurality of touch sensing electrodes, which are separately arranged in parallel along a vertical direction, and insulated and crossed with the plurality of touch driving electrodes, touch driving circuits, which are located in two side regions of the touch display panel, and electrically coupled with all the touch driving electrodes, a touch sensing circuit, which is located in lower region of the touch display panel, and electrically coupled with all the touch sensing electrodes, and an IC driving module, which is electrically coupled to the touch driving circuits and the touch sensing circuit;

an amount of the plurality of touch driving electrodes is N, and m is an integer larger than 1 and can divide N, and the touch driving circuit comprises m control signal lines, and N/m touch driving signal lines, and m TFTs respectively located corresponding to each of the touch driving signal lines;

in case that 1≦i≦N/m, gates of the m TFTs located corresponding to the ith touch driving signal line are respectively coupled to the first to the mth control signal lines, and sources are all coupled to the ith touch driving signal line, and drains are respectively coupled to one corresponding touch driving electrode through a bonding pad.

The control signal lines transmit control signals to control the m TFTs located corresponding to the ith touch driving signal line to be activated in order; as the touch driving signal lines transmit touch driving signals, and the m TFTs located corresponding to the ith touch driving signal line are activated in order, the touch driving signals are transmitted to the touch driving electrodes through the TFTs.

The control signal and the touch driving signal are both generated by the IC driving module.

The control signal and the touch driving signal are both periodic pulse signals, and a pulse high voltage level duration of the touch driving signal is m times of a pulse high voltage level duration of the control signal.

For two adjacent touch driving signals, a falling edge of the former touch driving signal and a rising edge of the latter touch driving signal are generated at the same time, for the two adjacent control signals, a falling edge of the former control signal and the rising edge of the latter control signal are generated at the same time.

The touch sensing circuit senses the touch sending signal.

The touch sensing signal is returned to the IC driving module through the touch sensing circuit.

The narrow frame In cell type touch display panel structure further comprises a GOA circuit located at an external side of the touch driving circuit.

The present invention further provides a narrow frame In cell type touch display panel structure, comprising a plurality of touch driving electrodes, which are separately arranged in parallel along a horizontal direction, and located in a middle region of the touch display panel, a plurality of touch sensing electrodes, which are separately arranged in parallel along a vertical direction, and insulated and crossed with the plurality of touch driving electrodes, touch driving circuits, which are located in two side regions of the touch display panel, and electrically coupled with all the touch driving electrodes, a touch sensing circuit, which is located in lower region of the touch display panel, and electrically coupled with all the touch sensing electrodes, and an IC driving module, which is electrically coupled to the touch driving circuits and the touch sensing circuit;

an amount of the plurality of touch driving electrodes is N, and m is an integer larger than 1 and can divide N, and the touch driving circuit comprises m control signal lines, and N/m touch driving signal lines, and m TFTs respectively located corresponding to each of the touch driving signal lines;

in case that 1≦i≦N/m, gates of the m TFTs located corresponding to the ith touch driving signal line are respectively coupled to the first to the mth control signal lines, and sources are all coupled to the ith touch driving signal line, and drains are respectively coupled to one corresponding touch driving electrode through a bonding pad;

wherein the control signal lines transmit control signals to control the m TFTs located corresponding to the ith touch driving signal line to be activated in order; as the touch driving signal lines transmit touch driving signals, and the m TFTs located corresponding to the ith touch driving signal line are activated in order, the touch driving signals are transmitted to the touch driving electrodes through the TFTs;

wherein the touch sensing circuit senses the touch sending signal;

the structure further comprises a GOA circuit located at an external side of the touch driving circuit.

The benefits of the present invention are: the present invention provides a narrow frame In cell type touch display panel structure, and by locating m control signal lines, and N/m touch driving signal lines and m TFTs respectively located corresponding to each of the touch driving signal lines, the touch driving signal can be provided to the N touch driving electrodes. In comparison with prior art that the N touch driving signal lines of the same amount of the N touch driving electrodes are located, the present invention can reduce the amount of the signal lines in the frame regions at two sides of the panel to reduce the width of the frame regions for being beneficial to realization of the narrow frame design.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a diagram of an In cell type touch display panel structure according to prior art;

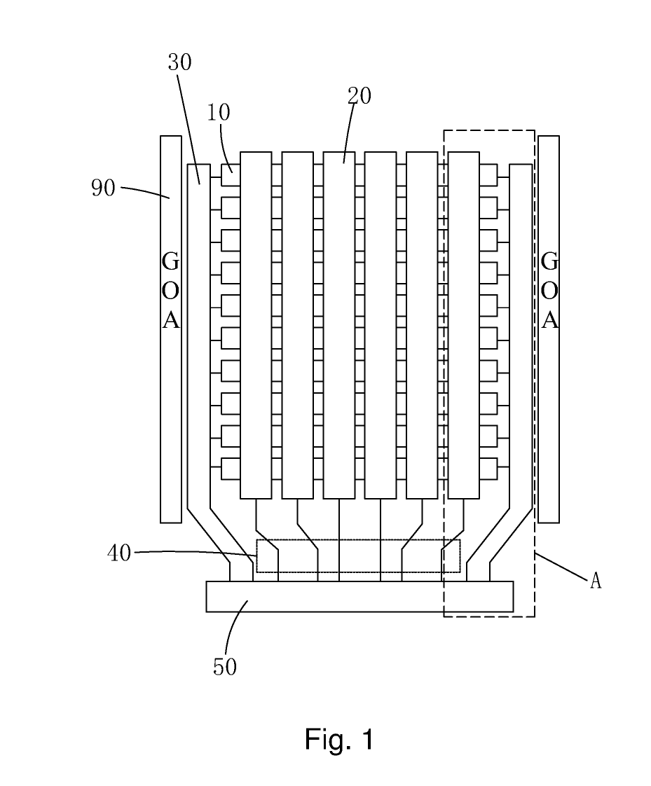

FIG. 2 is a detail diagram of A position in FIG. 1;

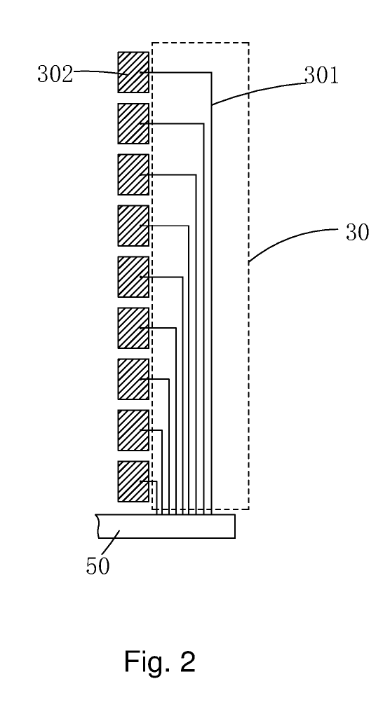

FIG. 3 is a diagram of a narrow frame In cell type touch display panel structure according to the present invention;

FIG. 4 is a detail diagram of B position in FIG. 3;

FIG. 5 is a signal sequence diagram of the narrow frame In cell type touch display panel structure according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

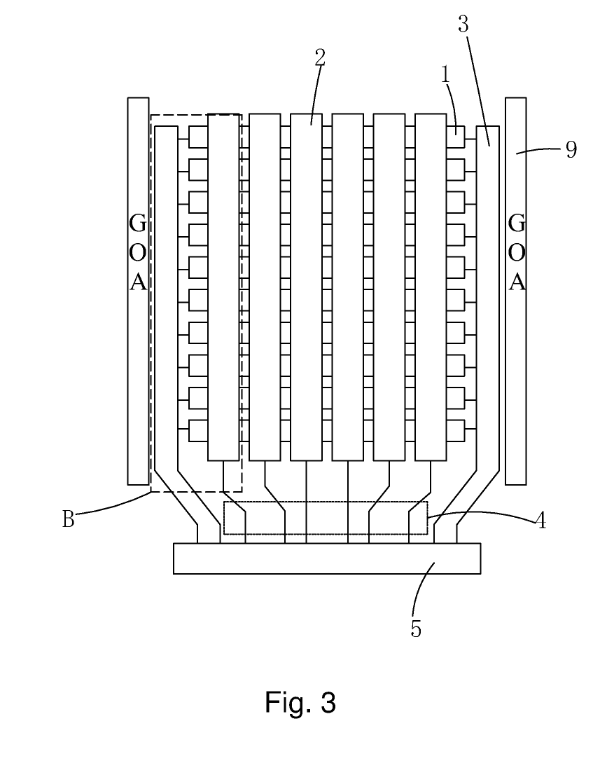

Please refer from FIG. 3 to FIG. 5. The present invention provides a narrow frame In cell type touch display panel structure, comprising a plurality of touch driving electrodes 1, which are separately arranged in parallel along a horizontal direction, and located in a middle region of the touch display panel, a plurality of touch sensing electrodes 2, which are separately arranged in parallel along a vertical direction, and insulated and crossed with the plurality of touch driving electrodes 1, touch driving circuits 3, which are located in two side regions of the touch display panel, and electrically coupled with all the touch driving electrodes 1, a touch sensing circuit 4, which is located in lower region of the touch display panel, and electrically coupled with all the touch sensing electrodes 2, an IC driving module 5, which is electrically coupled to the touch driving circuits 3 and the touch sensing circuit 4, and a GOA circuit 9 located at an external side of the touch driving circuit 3.

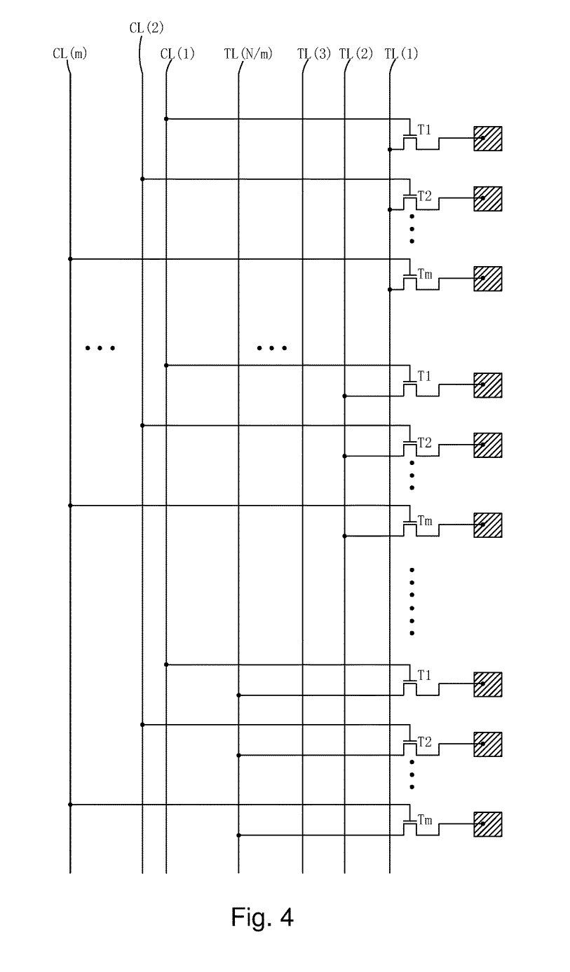

An amount of the plurality of touch driving electrodes 1 is N, and m is an integer larger than 1 and can divide N, and as shown in FIG. 4, the touch driving circuit 3 comprises m control signal lines CL(1) to CL(m), and N/m touch driving signal lines TL(1) to TL(N/m), and m TFTs T1 to Tm respectively located corresponding to each of the touch driving signal lines.

For instance, if N is 30, and m is 3, and the amount of the plurality of touch driving electrodes 1 is 30, and the touch driving circuit 3 comprises 3 control signal lines CL(1), CL(2), CL(3), and 10 touch driving signal lines TL(1) to TL(10), and 3 TFTs T1 to T3 respectively located corresponding to each of the touch driving signal lines. Thus, the total amount of the signal lines is 13, and the prior art requires 30 touch driving signal lines. In comparison, the amount of the signal lines can be significantly decreased. One more example, if N is 30, and m is 5, and the amount of the plurality of touch driving electrodes 1 is 30, and the touch driving circuit 3 comprises 5 control signal lines CL(1) to CL(5), and 6 touch driving signal lines TL(1) to TL(6), and 5 TFTs T1 to T5 respectively located corresponding to each of the touch driving signal lines. Thus, the total amount of the signal lines is 11, which is far less than the amount of the signal lines in prior art. Such arrangement can reduce the amount of the signal lines in the frame regions at two sides of the panel to reduce the width of the frame regions for being beneficial to realization of the narrow frame design.

In case that 1≦i≦N/m, gates of the m TFTs located corresponding to the ith touch driving signal line TL(i) are respectively coupled to the first to the mth control signal lines CL(1) to CL(m), and sources are all coupled to the ith touch driving signal line TL(i), and drains are respectively coupled to one corresponding touch driving electrode 1 through a bonding pad 32.

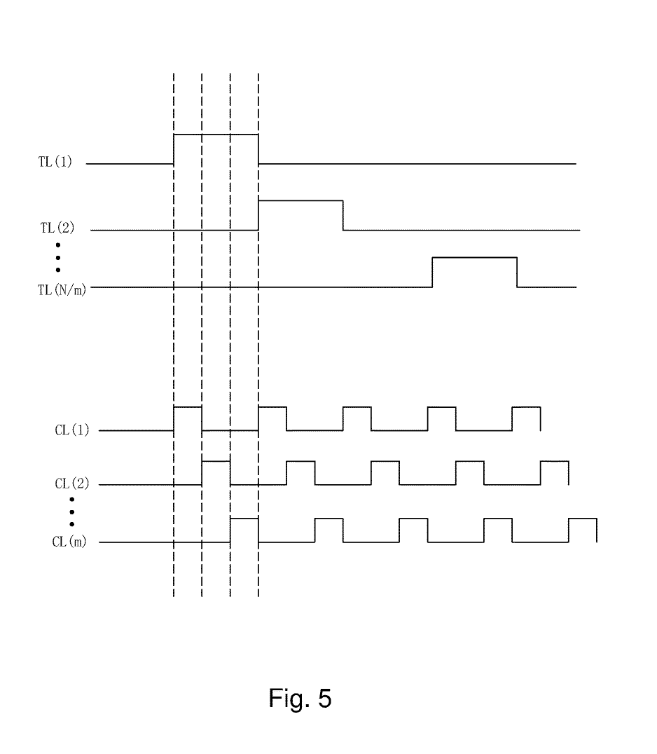

With combination of FIG. 3, FIG. 4, and FIG. 5, the control signal lines CL(1) to CL(m) transmit control signals to control the m TFTs located corresponding to the ith touch driving signal line TL(i) to be activated in order; as the touch driving signal lines CL(1) to CL(m) transmit touch driving signals, and the m TFTs located corresponding to the ith touch driving signal line TL(i) are activated in order, the touch driving signals are transmitted to the touch driving electrodes 1 through the TFTs.

Specifically, the control signal and the touch driving signal are both generated by the IC driving module 5.

The control signal and the touch driving signal are both periodic pulse signals, and a pulse high voltage level duration of the touch driving signal is m times of a pulse high voltage level duration of the control signal.

For two adjacent touch driving signals, a falling edge of the former touch driving signal and a rising edge of the latter touch driving signal are generated at the same time, for the two adjacent control signals, a falling edge of the former control signal and the rising edge of the latter control signal are generated at the same time.

The touch sensing circuit 4 senses the touch sending signal, and the touch sensing signal is returned to the IC driving module 5 through the touch sensing circuit 4.

Still, that N is 30, and m is 3 is illustrated. The gates of the 3 TFTs located corresponding to the first touch driving signal line TL(1) are respectively coupled to the first to the third control signal lines CL(1) to CL(3), and the sources are all coupled to the first touch driving signal line TL(1), and drains are respectively coupled to one corresponding touch driving electrode 1 through a bonding pad 32, and a pulse high voltage level duration of the touch driving signal is m times of a pulse high voltage level duration of the control signal, and as the touch driving signal transmitted in the first touch driving signal line TL(1) is high voltage level, the control signal lines CL(1) to CL(3) sequentially transmit the control signals of high voltage to successively control the TFT T1, TFT T2, TFT T3 located corresponding to the first touch driving signal line TL(1) to be activated in order for transmitting the touch driving signals to the first to the third touch driving electrodes 1; similarly, the gates of the 3 TFTs located corresponding to the second touch driving signal line TL(2) are respectively coupled to the first to the third control signal lines CL(1) to CL(3), and the sources are all coupled to the second touch driving signal line TL(2), and drains are respectively coupled to one corresponding touch driving electrode 1 through a bonding pad 32, and as the touch driving signal transmitted in the second touch driving signal line TL(2) is high voltage level, the control signal lines CL(1) to CL(3) sequentially transmit the control signals of high voltage to successively control the TFT T1, TFT T2, TFT T3 located corresponding to the second touch driving signal line TL(2) to be activated in order for transmitting the touch driving signals to the fourth to the sixth touch driving electrodes 1; and then the gates of the 3 TFTs located corresponding to the tenth touch driving signal line TL(10) are respectively coupled to the first to the third control signal lines CL(1) to CL(3), and the sources are all coupled to the tenth touch driving signal line TL(10), and drains are respectively coupled to one corresponding touch driving electrode 1 through a bonding pad 32, and as the touch driving signal transmitted in the tenth touch driving signal line TL(10) is high voltage level, the control signal lines CL(1) to CL(3) sequentially transmit the control signals of high voltage to successively control the TFT T1, TFT T2, TFT T3 located corresponding to the tenth touch driving signal line TL(10) to be activated in order for transmitting the touch driving signals to the twenty-eighth to the thirtieth touch driving electrodes 1, and thus, with 13 signal lines of fewer amount, the touch driving signals are transmitted to all the 30 touch driving electrodes.

Certainly, the present invention has not specific limitations to the amount N of the touch driving electrodes 1, the amount N of the control signal lines and the amount N/m of the touch driving signal lines. As long as it is ensured that m is an integer larger than 1 and can divide N, in condition that the more the amount N of the touch driving electrodes 1 is, the effect of the present invention of reducing the amount of the signal lines in the frame regions at two sides of the panel to reduce the width of the frame regions can be more obvious. For instance, N is 3000, and m is 30, then the amount of the touch driving electrodes 1 is 3000, and the amount of the control signal lines is 30, and the amount of the touch driving signal lines is 100. In comparison with prior art, which requires arrangement of 3000 touch driving signal lines, the present invention only needs to set up 130 signal lines.

In conclusion, in the narrow frame In cell type touch display panel structure of the present invention, by locating m control signal lines, and N/m touch driving signal lines and m TFTs respectively located corresponding to each of the touch driving signal lines, the touch driving signal can be provided to the N touch driving electrodes. In comparison with prior art that the N touch driving signal lines of the same amount of the N touch driving electrodes are located, the present invention can reduce the amount of the signal lines in the frame regions at two sides of the panel to reduce the width of the frame regions for being beneficial to realization of the narrow frame design.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A narrow frame In cell type touch display panel structure, comprising a plurality of touch driving electrodes, which are separately arranged in parallel along a horizontal direction, and located in a middle region of the touch display panel, a plurality of touch sensing electrodes, which are separately arranged in parallel along a vertical direction, and insulated and crossed with the plurality of touch driving electrodes, touch driving circuits, which are located in two side regions of the touch display panel, and electrically coupled with all the touch driving electrodes, a touch sensing circuit, which is located in lower region of the touch display panel, and electrically coupled with all the touch sensing electrodes, and an IC driving module, which is electrically coupled to the touch driving circuits and the touch sensing circuit;
an amount of the plurality of touch driving electrodes is N, and m is an integer larger than 1 and can divide N, and the touch driving circuit comprises m control signal lines, and N/m touch driving signal lines, and m TFTs respectively located corresponding to each of the touch driving signal lines;
in case that 1≦i≦N/m, gates of them TFTs located corresponding to the ith touch driving signal line are respectively coupled to the first to the mth control signal lines, and sources are all coupled to the ith touch driving signal line, and drains are respectively coupled to one corresponding touch driving electrode through a bonding pad.

2. The narrow frame In cell type touch display panel structure according to claim 1, wherein the control signal lines transmit control signals to control the m TFTs located corresponding to the ith touch driving signal line to be activated in order; as the touch driving signal lines transmit touch driving signals, and the m TFTs located corresponding to the ith touch driving signal line are activated in order, the touch driving signals are transmitted to the touch driving electrodes through the TFTs.

3. The narrow frame In cell type touch display panel structure according to claim 2, wherein the control signal and the touch driving signal are both generated by the IC driving module.

4. The narrow frame In cell type touch display panel structure according to claim 2, wherein the control signal and the touch driving signal are both periodic pulse signals, and a pulse high voltage level duration of the touch driving signal is m times of a pulse high voltage level duration of the control signal.

5. The narrow frame In cell type touch display panel structure according to claim 4, wherein for two adjacent touch driving signals, a falling edge of the former touch driving signal and a rising edge of the latter touch driving signal are generated at the same time, for the two adjacent control signals, a falling edge of the former control signal and the rising edge of the latter control signal are generated at the same time.

6. The narrow frame In cell type touch display panel structure according to claim 1, wherein the touch sensing circuit senses the touch sending signal.

7. The narrow frame In cell type touch display panel structure according to claim 6, wherein the touch sensing signal is returned to the IC driving module through the touch sensing circuit.

8. The narrow frame In cell type touch display panel structure according to claim 1, wherein the structure further comprises a GOA circuit located at an external side of the touch driving circuit.

9. A narrow frame In cell type touch display panel structure, comprising a plurality of touch driving electrodes, which are separately arranged in parallel along a horizontal direction, and located in a middle region of the touch display panel, a plurality of touch sensing electrodes, which are separately arranged in parallel along a vertical direction, and insulated and crossed with the plurality of touch driving electrodes, touch driving circuits, which are located in two side regions of the touch display panel, and electrically coupled with all the touch driving electrodes, a touch sensing circuit, which is located in lower region of the touch display panel, and electrically coupled with all the touch sensing electrodes, and an IC driving module, which is electrically coupled to the touch driving circuits and the touch sensing circuit;
an amount of the plurality of touch driving electrodes is N, and m is an integer larger than 1 and can divide N, and the touch driving circuit comprises m control signal lines, and N/m touch driving signal lines, and m TFTs respectively located corresponding to each of the touch driving signal lines;
in case that 1≦i≦N/m, gates of the m TFTs located corresponding to the ith touch driving signal line are respectively coupled to the first to the mth control signal lines, and sources are all coupled to the ith touch driving signal line, and drains are respectively coupled to one corresponding touch driving electrode through a bonding pad;
wherein the control signal lines transmit control signals to control the m TFTs located corresponding to the ith touch driving signal line to be activated in order; as the touch driving signal lines transmit touch driving signals, and the m TFTs located corresponding to the ith touch driving signal line are activated in order, the touch driving signals are transmitted to the touch driving electrodes through the TFTs;
wherein the touch sensing circuit senses the touch sending signal;
the structure further comprises a GOA circuit located at an external side of the touch driving circuit.

10. The narrow frame In cell type touch display panel structure according to claim 9, wherein the control signal and the touch driving signal are both generated by the IC driving module.

11. The narrow frame In cell type touch display panel structure according to claim 9, wherein the control signal and the touch driving signal are both periodic pulse signals, and a pulse high voltage level duration of the touch driving signal is m times of a pulse high voltage level duration of the control signal.

12. The narrow frame In cell type touch display panel structure according to claim 11, wherein for two adjacent touch driving signals, a falling edge of the former touch driving signal and a rising edge of the latter touch driving signal are generated at the same time, for the two adjacent control signals, a falling edge of the former control signal and the rising edge of the latter control signal are generated at the same time.

13. The narrow frame In cell type touch display panel structure according to claim 9, wherein the touch sensing signal is returned to the IC driving module through the touch sensing circuit.
